(19) United States
(12) Patent Application Publication
(10) Pub. No.: US 2004/0092636 A1
(43) Pub. Date: May 13, 2004

(54) Golf ball

(75) Inventors: Rastko Gajic, Oceanside, CA (US); Pijush K. Dewanjee, Carlsbad, CA (US)

Correspondence Address: CALLAWAY GOLF C0MPANY, 2180 RUTHERFORD ROAD, CARLSBAD, CA, 92008-7328, US

(73) Assignee: Callaway Golf Company, Carlsbad, CA

(21) Appl. No.: 10/065,670

(22) Filed: Nov. 7, 2002

(51) Int. Cl. C08K 3/20

(52) U.S. Cl. 524/406

(57) ABSTRACT

A golf ball core composed of a polybutadiene mixture containing zinc diacrylate with a particle size ranging from 3 to 5 microns. The golf ball core is preferably utilized with two-piece golf balls or solid three-piece golf balls. The golf ball core has a higher coefficient of restitution than a conventional core with a similar compression value. Alternatively, the golf ball core has a lower compression value than a conventional core with a similar coefficient of restitution value.

### FEDERAL RESEARCH STATEMENT

[Not applicable]

### BACKGROUND OF INVENTION

1. Field of the Invention

The present invention relates to a golf ball. More specifically, the present invention relates to a golf ball core.

2. Description of the Related Art

One problem associated with golf ball cores is producing a core that has a high coefficient of restitution value for greater distance and a lower compression value for better feel. In solid golf ball core formulations, zinc diacrylate is mixed with polybutadiene and other components to produce a golf ball core. The zinc diacrylate is a metallic co-agent that assists in cross-linking the components that form the golf ball core. Increasing the dispersion of the zinc diacrylate throughout the polybutadiene mixture is a persistent problem in the pertinent art.

### SUMMARY OF INVENTION

The present invention is a golf ball core that contains a zinc diacrylate that has an ultra-fine particle size. The present invention allows for a golf ball core that has a higher coefficient of restitution than a conventional core with a similar compression value. Alternatively, the present invention allows for a golf ball core that has a lower compression value than a conventional core with a similar coefficient of restitution value.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF DRAWINGS

FIG. 1 is a cross-sectional view of a three-piece solid golf.

FIG. 2 is a cross-sectional view of a two-piece golf ball.

### DETAILED DESCRIPTION

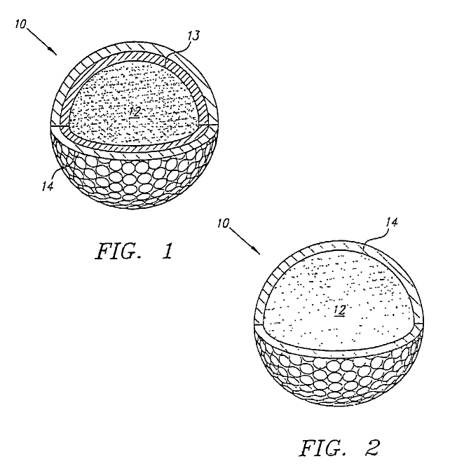

Most solid golf balls 10 are either two piece, as shown in FIG. 1, or three piece, as shown in FIG. 2. A solid two-piece golf ball 10 has a solid core 12 and a cover 16, that is usually composed of an ionomer or other thermoplastic material. A solid three-piece golf ball 10 has at least one intermediate layer 14 in addition to the solid core 12 and the cover 16. Those skilled in the relevant art will recognize that other golf ball constructions, such as wound golf balls, four piece golf balls and the like, could utilize a core produced according to the present invention.

The core 12 of the golf ball 10 is the “engine” for the golf ball 10 such that the inherent properties of the core 12 will strongly determine the initial velocity and distance of the golf ball 10. A higher initial velocity will usually result in a greater overall distance for a golf ball. In this regard, the Rules of Golf, approved by the United States Golf Association (“USGA”) and The Royal and Ancient Golf Club of Saint Andrews, limits the initial velocity of a golf ball to 250 feet (76.2 m) per second (a two percent maximum tolerance allows for an initial velocity of 255 per second) and the overall distance to 280 yards (256 m) plus a six percent tolerance for a total distance of 296.8 yards (the six percent tolerance may be lowered to four percent). A complete description of the Rules of Golf are available on the USGA web page at www.usga.org. Thus, the initial velocity and overall distance of a golf ball must not exceed these limits in order to conform to the Rules of Golf. Therefore, the core 12 for a USGA approved golf ball is constructed to enable the golf ball 10 to meet, yet not exceed, these limits.

The coefficient of restitution (“COR”) is a measure of the resilience of a golf ball. The COR is a measure of the ratio of the relative velocity of the golf ball after direct impact with a hard surface to the relative velocity before impact with the hard surface. The COR may vary from 0 to 1, with 1 equivalent to a completely elastic collision and 0 equivalent to a completely inelastic collision. A golf ball having a COR value closer to 1 will generally correspond to a golf ball having a higher initial velocity and a greater overall distance. If the golf ball has a high COR (more elastic), then the initial velocity of the golf ball will be greater than if the golf ball had a low COR. In general, a higher compression core will result in a higher COR value.

The core 12 of the golf ball 10 is generally composed of a blend of a base rubber, a cross-linking agent, a free radical initiator, and one or more fillers or processing aids. A preferred base rubber is a polybutadiene having a cis-1,4 content above 90%, and more preferably 98% or above.

The use of cross-linking agents in a golf ball core is well known, and metal acrylate salts are examples of such cross-linking agents. For example, metal salt diacrylates, dimethacrylates, or mono(meth)acrylates are preferred for use in the golf ball cores of the present invention, and zinc diacrylate is a particularly preferred cross-linking agent. A commercially available suitable zinc diacrylate is PC300 available from Sartomer Co., Inc., Exton, Pa. PC300 has a specific gravity of 1.677 grams per cubic centimeter and a molecular weight of 207. The zinc diacrylate particles of PC300 have a particle size of 3 to 5 microns compared to 10-12 microns for conventional zinc diacrylates. Use of an ultrafine particle size zinc diacrylate such as PC300 allows for greater dispersion of the zinc diacrylate throughout the polybutadiene blend which results in use of less zinc diacrylate, more polybutadiene, and a greater coefficient of restitution for the core 12.

In the manufacturing process it may be beneficial to pre-mix some cross-linking agent(s), such as, e.g., zinc diacrylate, with the polybutadiene in a master batch prior to blending with other core components.

Free radical initiators are used to promote cross-linking of the base rubber and the cross-linking agent. Suitable free radical initiators for use in the golf ball core 12 of the present invention include peroxides such as dicumyl peroxide, α-α-bis-(t-butyl peroxy)diisopropyl benzene, t-butyl perbenzoate, di-t-butyl peroxide, 2,5-dimethyl-2,5-di-t-butylperoxy-hexane, 1,1-di(t-butylperoxy)3,3,5-trimethyl cyclohexane, and the like, all of which are readily commercially available.

Zinc oxide is also preferably included in the core formulation. Zinc oxide may primarily be used as a weight adjusting filler, and is also believed to participate in the cross-linking of the other components of the core (e.g. as an activator). Additional processing aids such as dispersants and reinforcing agents may optionally be included. In particular, zinc stearate may be added as a processing aid. Any of a number of specific gravity adjusting fillers may be included to obtain a preferred total weight of the core 12. Examples of such fillers include tungsten and barium sulfate. All such processing aids and fillers are readily commercially available. The present inventors have found a particularly useful tungsten filler is WP102 Tungsten (having a 3 micron particle size) available from Atlantic Equipment Engineers (a division of Micron Metals, Inc.), Bergenfield, N.J.

Table One below provides the ranges of materials included in the preferred core formulations of the present invention.

TABLE ONE
Core Formulations

| Component | Preferred Range | | Most Preferred Range | |
|---|---|---|---|---|
| Polybutadiene | 100 | parts | 100 | parts |
| Zinc diacrylate | 20-30 | phr | 22-27 | phr |
| (ultra-fine size) | | | | |
| Zinc oxide | 0-50 | phr | 5-15 | phr |
| Zinc stearate | 0-15 | phr | 1-10 | phr |
| Peroxide | 0.2-2.5 | phr | 0.5-1.5 | phr |
| Filler | As desired | | As desired | |
| (e.g. tungsten) | (e.g. 2-11 | phr) | (e.g. 2-11 | phr) |

In a preferred form, the finished core 12 has a diameter of about 1.35 to about 1.64 inches for a golf ball 10 having an outer diameter of 1.68 inches. The core weight is preferably maintained in the range of about 32 to about 40 g. The core PGA compression is preferably maintained in the range of about 50 to 90, and most preferably about 55 to 80.

As used herein, the term “PGA compression” is defined as follows:

PGA compression value=180 Riehle compression value

The Riehle compression value is the amount of deformation of a golf ball in inches under a static load of 200 pounds, multiplied by 1000. Accordingly, for a deformation of 0.095 inches under a load of 200 pounds, the Riehle compression value is 95 and the PGA compression value is 85.

As is described above, the golf ball 10 may have at least one layer, the cover 16 or the boundary layer 14, that is composed of a thermoplastic (e.g. thermoplastic or thermoplastic elastomer) or a blend of thermoplastics (e.g. metal containing, non-metal containing or both). A polybutadiene core 12 requires an oxygen barrier layer, which is provided by the cover 16 or the boundary layer 14. Failure to provide an oxygen barrier layer will result in a core that is oxidized and thus very hard. Most thermoplastic materials provide some form of oxygen barrier. The thermoplastic may contain organic chain molecules and metal ions. The metal ion may be, for example, sodium, zinc, magnesium, lithium, potassium, cesium, or any polar metal ion that serves as a reversible cross-linking site and results in high levels of resilience and impact resistance. Suitable commercially available thermoplastics are ionomers based on ethylene copolymers and containing carboxylic acid groups with metal ions such as described above. The acid levels in such suitable ionomers may be neutralized to control resiliency, impact resistance and other like properties. In addition, other fillers with ionomer carriers may be used to modify (e.g. preferably increase) the specific gravity of the thermoplastic blend to control the moment of inertia and other like properties. Exemplary commercially available thermoplastic materials suitable for use in a boundary layer 14 or cover of a golf ball 10 include, for example, the following materials and/or blends of the following materials: HYTREL® and/or HYLENE® products from DuPont, Wilmington, Del., PEBAX® products from Elf Atochem, Philadelphia, Pa., SURLYN® products from DuPont, and/or ESCOR® or IOTEK® products from Exxon Chemical, Houston, Tex.

TABLE TWO

| | Core 1* | | Core 2 | | Core 3 | | Core 4 | |
|---|---|---|---|---|---|---|---|---|
| Component | parts | Grams | Parts | grams | parts | grams | parts | Grams |
| Polybutadiene | 100.0 | 500.0 | 100.0 | 500.0 | 100.0 | 500.0 | 100.0 | 500.0 |
| Zinc Diacrylate* | 27.0 | 135.0 | 0.0 | | 0.0 | | 0.0 | |
| 7-12 microns size | | | | | | | | |
| Zinc Diacrylate | 0.0 | | 24.0 | 120.0 | 23.5 | 117.5 | 22.0 | 110.0 |
| 3-5 microns size | | | | | | | | |
| Zinc Oxide | 15.8 | 79.0 | 3.0 | 15.0 | 4.5 | 22.5 | 25.0 | 125.0 |
| Zinc Stearate | 3.0 | 15.0 | 6.0 | 30.0 | 6.0 | 30.0 | 6.0 | 30.0 |
| Tungsten | 6.9 | 34.5 | 17.4 | 87.0 | 16.4 | 82.0 | 0.0 | 0.0 |
| Initiator | 1.0 | 5.0 | 1.0 | 5.0 | 1.0 | 5.0 | 1.0 | 5.0 |

TABLE THREE

| | Core 5* | | Core 6 | | Core 7 | | Core 8 | |
|---|---|---|---|---|---|---|---|---|
| Components | parts | Grams | Parts | Grams | parts | grams | parts | grams |
| Polybutadiene | 100.0 | 500.0 | 100.0 | 500.0 | 100.0 | 500.0 | 100.0 | 500.0 |
| Zinc Diacrylate* | 27.0 | 135.0 | 0.0 | | 0.0 | | 0.0 | |
| 7-12 microns size | | | | | | | | |
| Zinc Diacrylate | 0.0 | | 24.0 | 120.0 | 23.5 | 117.5 | 22.0 | 110.0 |
| 3-5 microns size | | | | | | | | |
| Zinc Oxide | 15.8 | 79.0 | 3.0 | 15.0 | 4.5 | 22.5 | 24.5 | 122.5 |
| Zinc Stearate | 3.0 | 15.0 | 6.0 | 30.0 | 6.0 | 30.0 | 6.0 | 30.0 |
| Tungsten | 6.9 | 34.5 | 17.4 | 87.0 | 16.4 | 82.0 | 0.0 | 0.0 |
| Initiator | 1.0 | 5.0 | 1.0 | 5.0 | 1.0 | 5.0 | 1.0 | 5.0 |

TABLE FOUR

| | Core 9* | | Core 10 | | Core 11 | | Core 12 | |
|---|---|---|---|---|---|---|---|---|
| Components | parts | Grams | Parts | Grams | parts | grams | parts | Grams |
| Polybutadiene | 100.0 | 500.0 | 100.0 | 500.0 | 100.0 | 500.0 | 100.0 | 500.0 |
| Zinc Diacrylate* | 27.0 | 135.0 | 0.0 | | 0.0 | | 0.0 | |
| 7-12 microns size | | | | | | | | |
| Zinc Diacrylate | 0.0 | | 23.0 | 115.0 | 23.5 | 117.5 | 24.0 | 120.0 |
| 3-5 microns size | | | | | | | | |
| Zinc Oxide | 15.80 | 79.00 | 15.10 | 75.50 | 4.50 | 22.50 | 0.00 | |
| Zinc Stearate | 3.0 | 15.0 | 6.0 | 30.0 | 6.0 | 30.0 | 6.0 | 30.0 |
| Tungsten | 6.9 | 34.5 | 7.8 | 39.0 | 16.4 | 82.0 | 19.9 | 99.5 |
| Initiator | 1.00 | 5.00 | 1.00 | 5.00 | 1.00 | 5.00 | 1.00 | 5.00 |

Each of the cores of Tables Two, Three and Four were processed as set forth in U.S. Pat. No. 6,465,546, for a Process For Manufacturing A Golf Ball Core. The control cores 1, 5 and 9 contained a zinc diacrylate of a conventional particle size, 7-12 microns, while cores 2-4, 6-8 and 10-12 contained a zinc diacrylate with an ultra-fine particle size, preferably ranging from 3 to 5 microns in size.

Table Five sets forth data for the twelve different cores listed in Tables Two, Three and Four. The mass of each of the cores is approximately 37 grams, and the diameter of each of the cores is approximately 1.542 inches. The compression of each of the cores is given as the Rhiele compression. The coefficient of restitution (COR) is reported at 143 feet per second (“fps”).

TABLE FIVE

| | Core | Core | Core | Core | Core |
|---|---|---|---|---|---|
| | Weight | Compression | Spec. Grav. | Diameter | COR |
| Core | (grams) | (points) | (g/cc) | (inches) | (points) |
| 1* | 37.12 | 71 | 1.188 | 1.542 | 78.24 |
| 2 | 37.08 | 70 | 1.187 | 1.542 | 78.91 |
| 3 | 36.91 | 57 | 1.184 | 1.542 | 78.18 |
| 4 | 37.24 | 75 | 1.192 | 1.542 | 78.54 |
| 5* | 37.06 | 74 | 1.188 | 1.542 | 78.41 |
| 6 | 37.06 | 72 | 1.188 | 1.542 | 78.84 |
| 7 | 37.09 | 71 | 1.188 | 1.542 | 78.85 |
| 8 | 37.02 | 70 | 1.185 | 1.542 | 78.25 |
| 9* | 37.05 | 72 | 1.189 | 1.540 | 78.17 |
| 10 | 37.09 | 70 | 1.189 | 1.542 | 78.38 |
| 11 | 37.13 | 70 | 1.187 | 1.542 | 78.41 |
| 12 | 37.07 | 57 | 1.185 | 1.543 | 77.59 |

The Coefficient of Restitution is the ratio of the velocity of separation (Vₒᵤₜ₁−Vₒᵤₜ₂) to the velocity of approach (Vᵢₙ₁−Vᵢₙ₂), where COR=(Vₒᵤₜ₁−Vₒᵤₜ₂)/(Vᵢₙ₁−Vᵢₙ₂). The value of COR will depend on the shape and material properties of the colliding bodies. In elastic impact, the COR is unity and there is no energy loss. A COR of zero indicates perfectly inelastic or plastic impact, where there is no separation of the bodies after collision and the energy loss is a maximum. In oblique impact, the COR applies only to those components of velocity along the line of impact or normal to the plane of impact. The coefficient of restitution between two materials can be measured by making one body many times larger than the other so that m₂ (mass of larger body) is infinitely large in comparison to m₁ (mass of the smaller body). The velocity of m₂ is unchanged for all practical purposes during impact and

COR=Vₒᵤₜ/Vᵢₙ

One particular type of COR test device that is commonly used in the golf ball industry is the ADC COR machine developed by Automated Design Corporation. Based on the definition of COR above, m₂ is a large 400 lb plate fixed vertically that the ball (m₁) is fired into. The impact of the core to a large fixed plate is an oblique impact. Software developed by Automated Design Corporation accurately calculates the normal velocities given the dimensions of the machine and outputs a value for Coefficient of Restitution as defined above.

The cores were kept in an incubator at a constant temperature of 23 degrees Celsius for at least three hours before they were tested for COR performance. The test begins by loading six cores and firing the first cores at approximately 80 feet per second, and ends with the last core firing approximately 180 feet per second. Each of the six cores are fired six times for a combined 48 shots over the range of speeds between 80-180 feet per second.

To determine the COR of a core at any specific incoming velocity, a third-order polynomial curve is fit through the 48 data points and constrained at the origin. This polynomial fit is extremely accurate (with an R\hat{ }2 fit value greater than 0.999) and allows the COR to be determined at an exact speed of 143 fps without actually having to achieve that specific cannon velocity. The COR is then obtained by plugging in 143 into the third-order polynomial equation and taking the ratio of outgoing velocity to incoming velocity to calculate the coefficient of restitution. For reference to ADC COR machine see Automated Design Corporation web-site at www.automateddesign.com.

Within each of the Tables Two, Three and Four, comparing the cores with the ultra-fine zinc diacrylate to the control core illustrates the benefits of using zinc diacrylate with ultra-fine particle size as compared to cores with standard zinc diarcylate. Of importance, is the ability to use a higher proportion of polybutadiene in the core with zinc diacrylate with ultra-fine particle size, which allows for a core with a similar Rhiele compression and a higher COR. For example, control core 1 has a Rhiele compression of 71 and a COR of 78.24 while core 2 has a Rhiele compression of 70 and a COR of 78.91.

The core 12 of the present invention is preferably utilized in a solid three-piece golf ball such as disclosed in U.S. Pat. No. 6,443,858 for a Golf Ball With High Coefficient Of Restitution, which is hereby incorporated by reference in its entirety, U.S. Pat. No. 6,190,268 for a Golf Ball With A Polyurethane Cover which is hereby incorporated by reference in its entirety, co-pending U.S. patent application Ser. No. 09/682,792 for a Golf Ball With High Coefficient Of Restitution, which is hereby incorporated by reference in its entirety, and/or golf balls with similar constructions. Alternatively, the core 12 of the present invention is utilized in a solid two-piece golf ball such as disclosed in co-pending U.S. patent application Ser. No. 09/847,094 for a Golf Ball, which is hereby incorporated by reference in its entirety, co-pending U.S. patent application Ser. No. 09/768,846 for a Golf Ball, which is hereby incorporated by reference in its entirety, and/or similar constructions. Alternatively, the core 12 of the present invention is utilized in a wound golf ball such as disclosed U.S. Pat. No. 6,379,266 for a Four Piece Golf Ball, which is hereby incorporated by reference in its entirety, and/or similar constructions.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

We claim as our invention:

1. A golf ball comprising:
a core having a diameter of 1.35 inches to 1.60 inches, the core comprising polybutadiene, zinc oxide in an amount of 7 to 15 parts per hundred parts of polybutadiene, zinc diacryalate in an amount of 20 to 35 parts per hundred parts of polybutadiene; an initiator in an amount of 0.1 to 1.0 parts per hundred parts of polybutadiene, and tungsten in an amount of 5 to 10 parts per hundred parts of polybutadiene, the core having a Rhiele compression of 60 to 90 points and wherein the zinc diacrylate has a particle size ranging from 3 to 5 microns;
an intermediate layer disposed on the core, the intermediate layer comprising an ionomer blend formed from a high acid ionomer resin neutralized with zinc, a high acid ionomer resin neutralized with sodium, and a terpolymer neutralized with magnesium, the cover having a flexural modulus ranging from 50,000 psi to 65,000 psi, a Shore D hardness ranging from 57-65; and
a cover disposed on the intermediate layer, the cover composed of a thermosetting polyurethane material and having a thickness ranging from 0.020 inch to 0.045 inch.

2. A golf ball comprising:
a core having a diameter of 1.35 inches to 1.60 inches, the core comprising polybutadiene, zinc oxide in an amount of 7 to 15 parts per hundred parts of polybutadiene, zinc diacryalate in an amount of 20 to 35 parts per hundred parts of polybutadiene; an initiator in an amount of 0.1 to 1.0 parts per hundred parts of polybutadiene, and tungsten in an amount of 5 to 10 parts per hundred parts of polybutadiene, the core having a Rhiele compression of 60 to 90 points and wherein the zinc diacrylate has a particle size ranging from 3 to 5 microns; and
a cover disposed on the core, the cover comprising an ionomer blend formed from a high acid ionomer resin neutralized with zinc, a high acid ionomer resin neutralized with sodium, and a terpolymer neutralized with magnesium, the cover having a flexural modulus ranging from 50,000 psi to 65,000 psi, a Shore D hardness ranging from 57-65.

3. A core for a golf ball, the core comprising:
the core comprising polybutadiene, zinc oxide in an amount of 7 to 15 parts per hundred parts of polybutadiene, an initiator in an amount of 0.1 to 1.0 parts per hundred parts of polybutadiene, and tungsten in an amount of 5 to 10 parts per hundred parts of polybutadiene, and zinc diacryalate in an amount of 20 to 35 parts per hundred parts of polybutadiene wherein the zinc diacrylate has a particle size ranging from 3 to 5 microns, wherein the core has a Rhiele compression of 60 to 80 points and a coefficient of restitution at 143 feet per second of at least 0.78.
